(19) United States
(12) Patent Application Publication
(10) Pub. No.: US 2003/0053669 A1
(43) Pub. Date: Mar. 20, 2003

(54) Magnetic resonance angiography method and apparatus

(75) Inventors: Jasjit S. Suri, Mayfield Hts., OH (US); Kecheng Liu, Solon, OH (US)

Correspondence Address: Thomas E. Kocovsky, Jr., FAY, SHARPE, FAGAN, MINNICH & McKEE, LLP, 1100 Superior Avenue. Seventh Floor, Cleveland, OH, 44114-2518, US

(73) Assignee: MARCONI MEDICAL SYSTEMS, INC.

(21) Appl. No.: 09/907,779

(22) Filed: Jul. 18, 2001

(51) Int. Cl. G06K 9/00

(52) U.S. Cl. 382/130

(57) ABSTRACT

In magnetic resonance angiography (MRA), the MRA data (40) is smoothed and converted into an isotropic format (52). A binary surface fitting mask (56) that differentiates vascular regions from surrounding tissue is generated from the isotropic MRA data. Vascular starting points (60) are identified based on the binary surface fitting mask. The vascular system corresponding to each starting point is tracked (62). The tracked vascular system is graphically displayed (68). Preferably, the arteries and the veins in the binary surface fitting mask data are differentiated (58) based on anatomical constraints. The tracking (62) preferably includes estimating an oblique plane that is orthogonal to the vessel (204), determining the vessel edges in the oblique plane (212), and determining an estimated vessel center in the oblique plane (216). The vessel edges are preferably determined by determining a raw vessel edge (208), and refining the raw vessel edge to obtain a refined vessel edge representation (212).

### BACKGROUND OF THE INVENTION

The present invention relates to the imaging and magnetic resonance arts. It particularly relates to magnetic resonance angiography and will be described with particular reference thereto. However, the invention will also find application in other imaging arts in which tubular structures and networks are advantageously characterized and in which similar tubular structures and networks are advantageously differentiated.

Angiography relates to the imaging of blood vessels and blood vessel systems. Angiography enables improved surgical planning and treatment, improved diagnosis and convenient non-invasive monitoring of chronic vascular diseases, and can provide an early warning of potentially fatal conditions such as aneurysms and blood clots.

Angiography is performed using a number of different medical imaging modalities, including biplane X-ray/DSA, magnetic resonance (MR), computed tomography (CT), ultrasound, and various combinations of these techniques. Magnetic resonance angiography (MRA) can be performed in a contrast enhanced mode wherein a contrast agent such as Gadolinium-Dithylene-Triamine-Penta-Acetate is administered to the patient to improve vascular MR contrast, or in a non-contrast enhanced mode. Vascular contrast is typically obtained by imaging the flowing blood using MR imaging techniques such as time of flight (TOF), black-blood, phase contrast, T2, or T2* imaging.

The TOF method is prevalent in MRA. A TOF imaging sequence typically includes the steps of exciting a magnetic resonance in a first tissue slice using a 90° RF pulse, followed by applying a 180° phase-refocusing RF pulse to a nearby second slice. There is a pre-selected time delay between the 90° and 180° RF pulses. Blood that has flowed from the first slice into the second slice during the time delay experiences both the 90° excitation pulse and the 180° refocusing pulse and so produces a spin echo that is selectively imaged in the TOF technique. TOF as well as most other MRA methods produce a gray scale three-dimensional image in which the blood vessels (or the blood within the blood vessels) appear either brighter (white blood angiographic techniques) or darker (black blood angiographic techniques) than the surrounding tissues.

Analysis and interpretation of the unprocessed gray scale MRA image is complicated by a number of factors. Complexity arises because blood vessel networks in the human body are highly intricate, and a particular image will typically include tortuous or occluded blood vessels, shape variability, regions of very high blood vessel densities, a wide range of blood vessel diameters, and gaps in blood vessels that complicate tracking. Additionally, MRA techniques often do not provide an appreciable differentiation between the arterial and the venous vascular sub-systems.

The MRA data acquisition introduces additional complications such as misleading gray scales due to limited dynamic range, partial volume averaging wherein a voxel includes a mixture of tissues, competing MR contrast mechanisms, and artifacts due to patient motion and system noise. MRA data acquisition is typically performed using applied slice-selective and spatial encoding gradients which produce slices and readout lines that are aligned with the conventional orthogonal axial, sagittal, and coronal planes of the body. This arrangement introduces still further complications since the blood vessels typically do not lie in these conventional planes. Thus, blood vessels pass through the imaging slices at oblique angles ranging from 0° (blood vessel perpendicular to the imaging slice) to 90° (blood vessel lying in the slice plane).

The present invention contemplates an improved MRA system and method which overcomes the aforementioned limitations and others.

### SUMMARY OF THE INVENTION

According to one aspect of the invention, a method is disclosed for processing magnetic resonance angiographic (MRA) data. The MRA data is smoothed and converted to an isotropic format. A binary surface fitting mask that differentiates vascular regions from surrounding tissue is generated from the isotropic MRA data. Vascular starting points are identified as indicated by the binary surface fitting mask. The vascular system corresponding to each starting point is tracked. The tracked vascular system is displayed.

Preferably, the arteries and the veins in the binary surface fitting mask data are differentiated based on anatomical constraints. The differentiating can be based on the distance of the vascular starting points from a centerline of the body, or on the anatomical symmetry of the vascular system with respect to the sagittal plane of the body.

Preferably, the vascular starting points are confirmed based on anatomical symmetry of the vascular system with respect to the sagittal plane of the body.

The step of generating a binary surface fitting mask preferably includes: calculating a noise value per pixel; calculating a signal value per pixel; calculating a signal-to-noise ratio per pixel; thresholding said signal-to-noise ratio; and repeating the steps of calculating a noise value per pixel, calculating a signal value per pixel, calculating a signal-to-noise ratio per pixel, and thresholding said signal-to-noise ratio for each pixel in the masked plane.

The tracking step preferably includes: estimating an oblique plane that is orthogonal to the vessel; determining the vessel edges in the oblique plane; determining an estimated vessel center in the oblique plane; and repeating the steps of estimating an oblique plane that is orthogonal to the vessel, determining the vessel edges in the oblique plane, and determining the vessel center for a plurality of points of the vessel. The step of determining an oblique plane preferably includes: computing a Weingarten matrix for the vector space (x, y, z, I(x,y,z)^{T} where x, y, and z are spatial coordinates, and I(x,y,z) is the MRA signal intensity at the location (x,y,z); obtaining the eigenvalues and the eigenvectors of the Weingarten matrix; identifying a vessel direction as the eigenvector corresponding to the minimum eigenvalue; and identifying an orthogonal plane as one of a plane defined by the eigenvectors other than the eigenvector corresponding to the minimum eigenvalue, and a plane that is orthogonal to the vessel direction.

The step of determining the vessel edges in the oblique plane preferably includes: determining a raw vessel edge; and refining the raw vessel edge to obtain a refined vessel edge representation. The step of determining a raw vessel edge preferably includes computing a scale space image by convolving the gradient of a Gaussian function with the oblique orthogonal plane image.

The step of refining the raw vessel edge to obtain a refined vessel edge representation preferably includes: calculating a fuzzy membership function for the pixels; defining at least one force acting on the vessel edges based on the fuzzy membership function; adjusting the vessel edge representation based on the computed action of the at least one force; and repeating the steps of defining at least one force and adjusting the vessel edge representation until a convergence is obtained.

The step of determining an estimated vessel center preferably includes calculating a center likelihood measure for a plurality of pixels contained within the vessel edges, and selecting a pixel from the plurality of pixels based on the calculated center likelihood measures. The step of calculating a center likelihood measure preferably includes calculating the distance from the pixel to a plurality of points on the refined vessel edges.

The method preferably further comprises the steps of identifying a bifurcation point, tagging said bifurcation point, and revisiting the tagged bifurcation point and repeating the tracking step along a vascular branch corresponding to the bifurcation point.

According to another aspect of the invention, a method is disclosed for tracking a vascular system imaged in a gray scale image of at least a portion of the body. A starting point for the vascular system is identified. An oblique plane that is orthogonal to the vessel is estimated, said oblique plane being comprised of pixels. The vessel edges in the oblique plane are determined. An estimated vessel center in the oblique plane is determined.

The step of determining an oblique plane preferably includes computing a Weingarten matrix for the vector space (x, y, z, I(x,y,z))^{T} where x, y, and z are spatial coordinates and I(x,y,z) is the gray scale value at the location (x,y,z), obtaining the eigenvalues and the eigenvectors of the Weingarten matrix, identifying a vessel direction as the eigenvector corresponding to the minimum eigenvalue, and identifying an orthogonal plane as one of a plane defined by the eigenvectors other than the eigenvector corresponding to the minimum eigenvalue, and a plane that is orthogonal to the vessel direction.

The step of determining the vessel edges in the oblique plane preferably includes determining a raw vessel edge, and refining the raw vessel edge to obtain a refined vessel edge representation. The step of determining a raw vessel edge can include computing a scale space image by convolving the gradient of a Gaussian function with the oblique orthogonal plane image. The step of refining the raw vessel edge to obtain a refined vessel edge representation can include calculating a fuzzy membership function for the pixels, defining at least one force acting on the vessel edges based on the fuzzy membership function, and adjusting the vessel edge representation based on the computed action of the at least one force.

The step of determining an estimated vessel center preferably includes calculating a center likelihood measure for a plurality of pixels contained within the vessel edges, and selecting a pixel from the plurality of pixels based on the calculated center likelihood measures. Calculating a center likelihood measure can include calculating the distance from the pixel to a plurality of points on the vessel edges.

The identifying of a starting point for the vascular system preferably includes generating a mask from the gray scale image data that differentiates vascular regions from surrounding tissue, and differentiating arteries and veins in the mask based on anatomical constraints.

According to yet another aspect of the invention, a method is disclosed for differentiating arteries and veins in gray scale image data. A mask is generated from the gray scale image data that differentiates vascular regions from surrounding tissue. Arteries and veins in the mask are differentiated based on anatomical constraints.

The differentiating of arteries and veins in the mask based on anatomical constraints preferably includes differentiating arteries and veins based on the distance of the vascular starting points from a selected area of the imaged body, or differentiating arteries and veins based on anatomical symmetry of the vascular system with respect to the sagittal plane of the body.

According to still yet another aspect of the invention, an apparatus for performing magnetic resonance angiography is disclosed. A magnetic resonance imaging apparatus generates a first image of a portion of the body. A vascular mask processor generates a mask image from the first image in which vascular regions are differentiated from the surrounding tissue. An artery/vein differentiation processor receives the vascular mask image and identifies at least one of an artery and a vein therefrom. A vascular tracking processor receives a vessel starting point based on the vascular mask image and calculates a skeleton of the vascular system associated with the starting point.

Preferably, the artery/vein differentiation processor includes a collection of anatomical constraints, and a comparator that compares the mask image with the anatomical constraints and identifies at least one of an artery and a vein based upon the comparison.

The vascular tracking processor preferably includes a spatial processor that estimates an oblique plane that is orthogonal to the vessel, an edge processor that determines the vessel edges in the oblique plane, and a skeleton processor that determines an estimated vessel center in the oblique plane.

One advantage of the present invention is that it provides robust edge-preserving smoothing of the MRA data that accommodates low signal-to-noise ratios, variations in intensities, and the like.

Another advantage of the present invention resides in improved accuracy of the subsequent vessel edge estimating.

Another advantage of the present invention is that it advantageously incorporates anatomical constraints as a tool for differentiating veins and arteries.

Another advantage of the present invention is that it advantageously incorporates fitting of surfaces of any degree to estimate the noise level in the images.

Another advantage of the present invention is that it provides a rapid method for accurately estimating the vessel directionality using an eigenvalue and eigenvector analysis.

Another advantage of the present invention is that it provides a rapid method for accurately estimating the vessel directionality using the higher order partial derivatives for image volumes.

Another advantage of the present invention is that it provides a rapid method for accurately estimating the vessel cross-sections.

Another advantage of the present invention is that it advantageously incorporates fuzzy pixel classification into the vessel cross-section estimation. This enables more accurate estimation of the vessel edges.

Yet another advantage of the present invention is that it uses the level set concept for refining the vessel edges representation. This method is very robust and inhibits leaking and false edge detection which are often encountered using less robust gradient-based methods.

Still yet another advantage of the present invention is that it is flexible and can be applied to a variety of different vascular systems throughout the body.

Still further advantages and benefits of the present invention will become apparent to those of ordinary skill in the art upon reading the following detailed description of the preferred embodiment.

### BRIEF DESCRIPTION OF THE DRAWINGS

The invention may take form in various components and arrangements of components, and in various steps and arrangements of steps. The drawings are only for the purpose of illustrating preferred embodiments and are not to be construed as limiting the invention.

FIG. 1 shows an exemplary magnetic resonance angiography apparatus in accordance with a preferred embodiment of the invention;

FIG. 2 shows a diagrammatic representation of a preferred embodiment of the post-acquisition vascular processing method in overview;

FIG. 3 shows a diagrammatic representation of a preferred embodiment of the generating of smoothed and isotropic MRA data;

FIG. 4 shows a diagrammatic representation of a preferred embodiment of the surface fitting mask generation;

FIG. 5 shows a representation of a coronal cross-section of an exemplary human body;

FIG. 6A shows a diagrammatic representation of the surface fitting mask corresponding to an axial slice indicated in FIG. 5;

FIG. 6B shows a diagrammatic representation of the identifying of left and right veins in the surface fitting mask of FIG. 6A;

FIG. 6C shows a diagrammatic representation of the venous mask corresponding to the surface fitting mask of FIG. 6A;

FIG. 6D shows a diagrammatic representation of the arterial mask corresponding to the surface fitting mask of FIG. 6A;

FIG. 6E shows a diagrammatic representation of the identifying of left and right arteries in the arterial mask of FIG. 6D;

FIG. 7 shows a diagrammatic representation of a preferred embodiment of the identifying of vascular starting points;

FIG. 8 shows a diagrammatic representation of a preferred embodiment of the vessel tracking system in overview;

FIG. 9 shows a diagrammatic representation of a preferred embodiment of the process for identifying an oblique plane that is orthogonal to the vessel;

FIG. 10 shows a diagrammatic representation of a preferred embodiment of the process for refining the raw vessel edges;

FIG. 11 shows a diagrammatic representation of a preferred embodiment of the process for estimating the center of the vessel cross-section;

FIG. 12 shows a representation of a bifurcation point in a vascular system; and

FIG. 13 shows a diagrammatic representation of a preferred embodiment of the process for graphically rendering the vascular system.

### DETAILED DESCRIPTION OF THE PREFERRED EMBODIMENTS

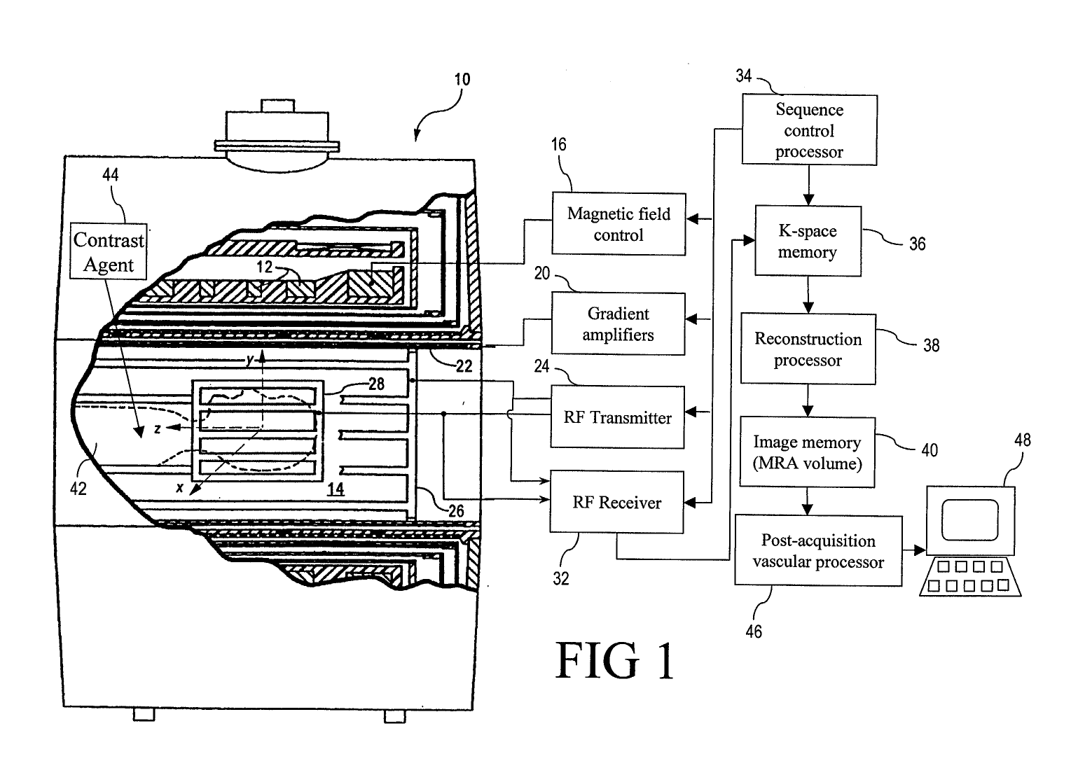

With reference to FIG. 1, a magnetic resonance imaging (MRI) scanner 10 typically includes superconducting or resistive magnets 12 that create a substantially uniform, temporally constant main magnetic field B₀ along a z-axis through an examination region 14. Although a bore-type magnet is illustrated in FIG. 1, the present invention is equally applicable to open magnet systems and other known types of MRI scanners. The magnets 12 are operated by a main magnetic field control 16. Imaging is conducted by executing a magnetic resonance (MR) sequence with the subject being imaged, e.g. a patient 42 in a magnetic resonance angiography (MRA) session, placed at least partially within the examination region 14, typically with the region of interest at the isocenter.

The magnetic resonance sequence entails a series of RF and magnetic field gradient pulses that are applied to the subject to invert or excite magnetic spins, induce magnetic resonance, refocus magnetic resonance, manipulate magnetic resonance, spatially and otherwise encode the magnetic resonance, to saturate spins, and the like. More specifically, gradient pulse amplifiers 20 apply current pulses to a whole body gradient coil assembly 22 to create magnetic field gradients along x-, y-, and z-axes of the examination region 14.

An RF transmitter 24, preferably digital, applies RF pulses or pulse packets to a whole-body RF coil 26 to transmit RF pulses into the examination region. A typical RF pulse is composed of a packet of immediately contiguous pulse segments of short duration which taken together with each other and any applied gradients achieve a selected magnetic resonance manipulation. The RF pulses are used to saturate, excite resonance, invert magnetization, refocus resonance, or manipulate resonance in selected portions of the examination region.

For whole-body applications, the resulting resonance signals, generated as a result of a selected manipulation, are also picked up by the whole-body RF coil 26. Alternately, for generating RF pulses in limited regions of the subject, local RF coils are placed contiguous to the selected region. For example, as is known in the art, an insertable head coil 28 is inserted surrounding a selected brain region at the isocenter of the bore. Other surface coils or other such specialized RF coils may also be employed. For example, the RF system optionally includes a phased array receive coil (not shown) whereby partial parallel imaging (PPI) techniques known to the art are enabled. Preferably, the whole-body RF coil 26 induces resonance and the local RF coil or coil array receives magnetic resonance signals emanating from the selected region. In other embodiments, the local RF coil both excites and receives the resulting magnetic resonance signals.

Regardless of the RF coil configuration and the application thereof, the resultant RF magnetic resonance signals that are picked up by one or another of the RF coils is received and demodulated by an RF receiver 32. Preferably, a sequence control processor 34 controls the magnetic field control 16, the gradient pulse amplifiers 20, the RF transmitter 24, and the RF receiver 32 to produce integrated MRI pulse sequence and readout waveforms that generate the magnetic resonance (MR) signals and optional echoes, provide appropriate encoding gradients to spatially encode the resultant MR response, and coordinate MR pickup and receive operations.

The MRI sequence typically includes a complex series of magnetic field gradient pulses and/or sweeps generated by the gradient amplifiers 20 which along with selected RF pulses generated by RF coils 26, 28 result in magnetic resonance echoes that map into k-space. The resultant magnetic resonance data is stored in a k-space memory 36. The k-space data is processed by a reconstruction processor 38, which is typically an inverse Fourier transform processor or other reconstruction processor known to the art, to produce a reconstructed image representation that is stored in an image memory 40.

In magnetic resonance angiography (MRA), a patient 42 is imaged by the MRI system 10 using imaging conditions that particularly emphasize the vascular system in the resultant image. In the exemplary FIG. 1, the carotid area of the patient 42 is imaged. Optionally, the patient receives a magnetic resonance contrast agent 44, e.g. a bolus injection of a Gadolinium-Dithylene-Triamine-Penta-Acetate, to improve the vascular contrast, e.g. contrast-enhanced MRA is performed. An MRA sequence such as a time-of-flight (TOF) sequence, a black-blood angiography sequence, or the like, is applied by the sequence control processor 34. These sequences can each be performed without the use of contrast agents. The sequence parameters for a preferred TOF embodiment include: TE=6.7 ms, TR=27 ms, FOV=20 cm, PE=192, NSA=1, flip-angle=35, gap=0 mm, and matrix size=384×512. Of course, those of ordinary skill in the art can tailor the pulse sequence program to generate better quality images for specific imaging situations using the image parameter control and type of weighting.

The k-space data is collected in the k-space memory 36 and reconstructed by the reconstruction processor 38 to generate the MRA volume image data 40. The MRA volume of the MRA experiment is preferably a three-dimensional gray scale image representation of the examined area of the patient that has good contrast for the vascular system relative to other body tissues of the patient 42. However, the arterial and venous data is undifferentiated, and the MRA volume image data 40 is unprocessed with respect to the vascular information contained therein.

A post-acquisition processor 46 processes the MRA volume image representation 40 to extract and/or highlight additional information about the imaged vascular system. The post processing preferably includes automated separation of the venous and arterial sub-systems, extraction of information about the blood vessel diameters and blood vessel networks, and the like. The resulting arterial and venous information is preferably graphically displayed on an appropriate user interface 48, and can of course also be stored electronically or on a magnetic storage medium, printed on paper, et cetera (not shown).

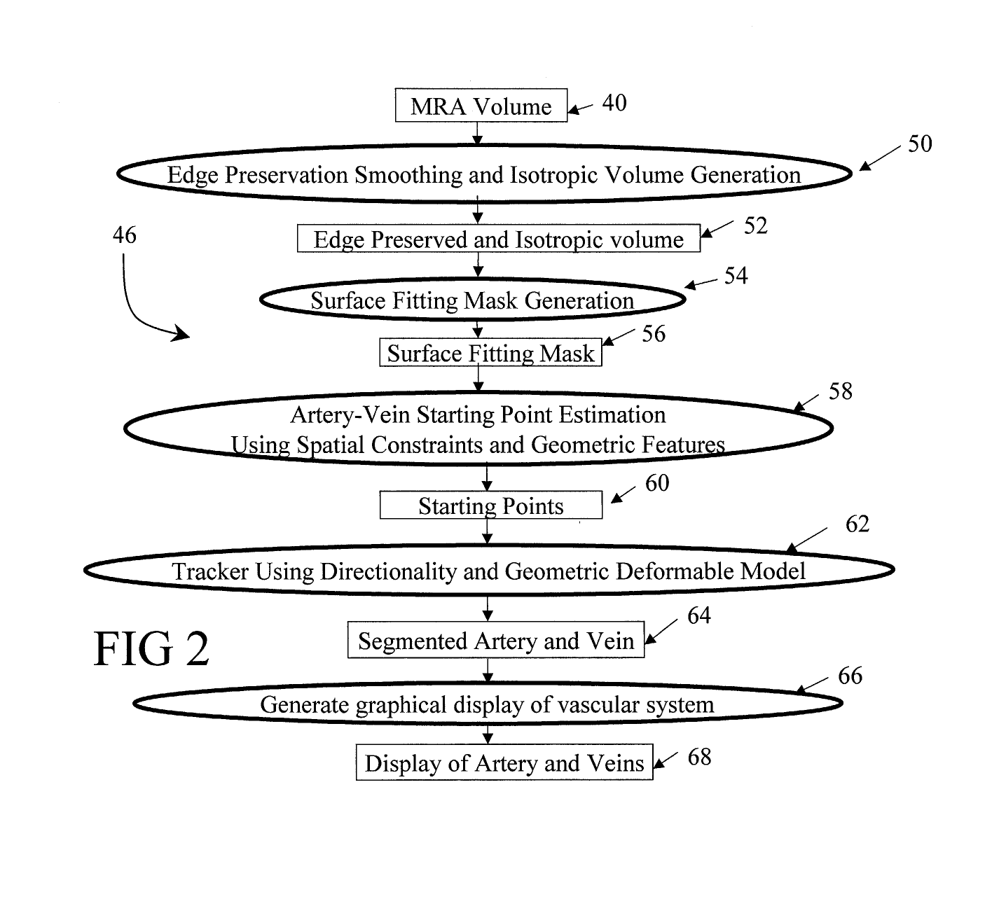

With reference now to FIG. 2, a preferred embodiment of a process implemented by the post-acquisition vascular processor 46 is described. The post-acquisition vascular processor 46 processes the MRA image volume 40 to particularly identify, extract, quantify, highlight, or otherwise enhance the vascular information contained therein. In a preferred embodiment, the post-acquisition vascular processor 46 executes five sequential steps, each step producing an intermediate image and/or information pertaining to the vascular system.

The gray scale MRA volume data is first smoothed, preferably in an edge-preserving manner, and re-segmented in a step 50 to produce edge-preserved, smoothed, and isotropic image volume data 52. Typically the acquired MRA data is aligned along the conventional orthogonal axial, sagittal, and coronal planes of the body. In the exemplary case of MRA imaging of the carotid vascular system, the image slices are typically axially-oriented slices, and the phase-encoding and readout directions are in the axial plane lying along one or the other of the sagittal and coronal directions. Each voxel is thus orthorhombic with sides in the axial, sagittal, and coronal planar orientations, but the acquired voxels are typically not cubic. The re-segmenting step 50 produces isotropic data 52 for which the voxels are cubic. The subsequent mathematical data manipulations are preferably applied to isotropic data.

The isotropic gray scale data 52 is converted to a binary form in a step 54 to generate a binary surface fitting mask 56. The binary surface fitting mask 56 preferably has two levels, a first level, e.g. black or “0”, corresponding to a voxel corresponding wholly or in greater part to a blood vessel portion, and a second level, e.g. white or “1”, corresponding to tissue wholly or predominantly outside of the vascular system. The binary mask generation step 54 is preferably applied to each slice of the isotropic volume 52, e.g. to each axial slice comprising the exemplary carotid vascular MRA image. Preferably, the generating step 52 produces a surface fitting mask 54 which reduces noise and clearly indicates the blood vessel cross-sections.

The surface fitting mask 56 is analyzed to differentiate the arterial and venous components in a step 58. This differentiation can be a manual differentiation, e.g. the user is graphically presented with a slice surface fitting mask 56 and the user indicates the veins or arteries, e.g. by a pointing device. However, this manual approach is labor intensive, particularly considering that typical MRA image data includes hundreds of slices. Manual selection of arteries and veins also requires specific anatomical knowledge on the part of the user. Preferably, the differentiation step 58 includes an automated step whereby the arteries and veins are differentiated without user input. In either case, the differentiating step 58 produces starting points 60 for the arterial and venous sub-systems of the imaged vascular area.

A tracker system tracks the blood vessels in a step 62. Preferably, the tracking 62 includes quantifying the artery vessel axis and the outer boundaries of the artery, with analogous tracking 62 performed for the venous sub-system. The tracking 62 is preferably performed on the edge preserved and isotropic processed gray scale MRA volume data 52, using the starting point identifications 60 to differentiate the arterial and venous sub-systems during the tracking. The output of the tracking step 62 is segmented arterial and venous sub-systems data 64.

The tracked vascular data is preferably used to generate a graphical display of the vascular system in a step 66. The display 68 can be on a color monitor, color printout, or the like.

Having provided an overview of the post-acquisition vascular processor 46 with reference to FIG. 2, the individual elements will next be described in greater detail.

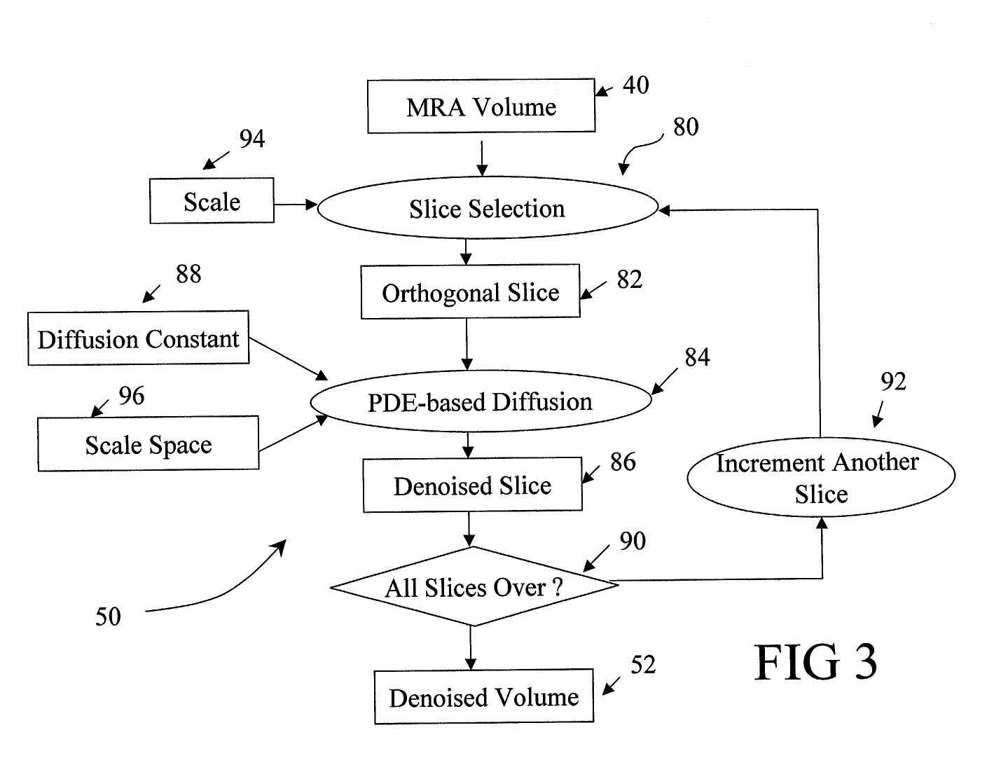

With reference now to FIG. 3, a preferred embodiment of the edge preserving smoothing and isotropic volume generating step 50 is described. A slice 82 is selected in a step 80 from the MRA image volume 40. The slice is smoothed in a step 84, preferably in an edge-preserving manner, to produce a denoised slice 86. In a preferred embodiment, a partial differential equation (PDE)-based diffusion smoothing is applied in the step 84 as follows:

$$I ( x , y ) = ∇ \cdot ( {D}^{t} ∇ I ) \\ w h e r e \\ {D}^{t} = exp [ - {( \frac{‖ ∇ {I}^{t} ‖}{k} )}^{2} ] \qquad ( 1 )$$

where k is a fixed diffusion constant 88 that is selected to provide edge preservation. The diffusion constant k is typically in the range 100 to 200. ∇I is the gradient of the image and ∇• is the divergence operator which operates on the gradient of the image. Note that the diffusivity D^{t} is time dependent and thus the smoothing process becomes an iterative process. Such an iterative equation can be preferably implemented numerically using discrete finite-difference methods known to the art. Those skilled in the art can optionally change the diffusion constant or change the exponential form to another exponential form having a faster decay. This system has the advantages of speed and edge preservation in addition to smoothing. Also, note that this edge preserved smoothed volume would play a greater role in regional-based scale-space edge detection for vessel cross-section estimation.

Edge-preserved PDE-based smoothing is robust and is typically effective in the presence of variations in the input volumes, e.g. low signal-to-noise ratios, system noise, etc. Of course, other appropriate edge-preserving smoothing methods known to the art can be substituted in the step 84.

A decision step 90 directs selective incrementing 92 to the next slice and cycles through the MRA volume data 40. Preferably, during the smoothing process, the dimensions of the gray scale voxels of the MRA image volume 40 are scaled appropriately to produce isotropic, i.e. cubic, voxels. For example, the slice thickness is preferably scaled appropriately 94 in the slice select step 80 and the dimensions in the phase encoding and readout directions are similarly scaled into scale space 96 during the denoising step 84. The resulting smoothed and isotropic data are preferably stored as the denoised volume 52.

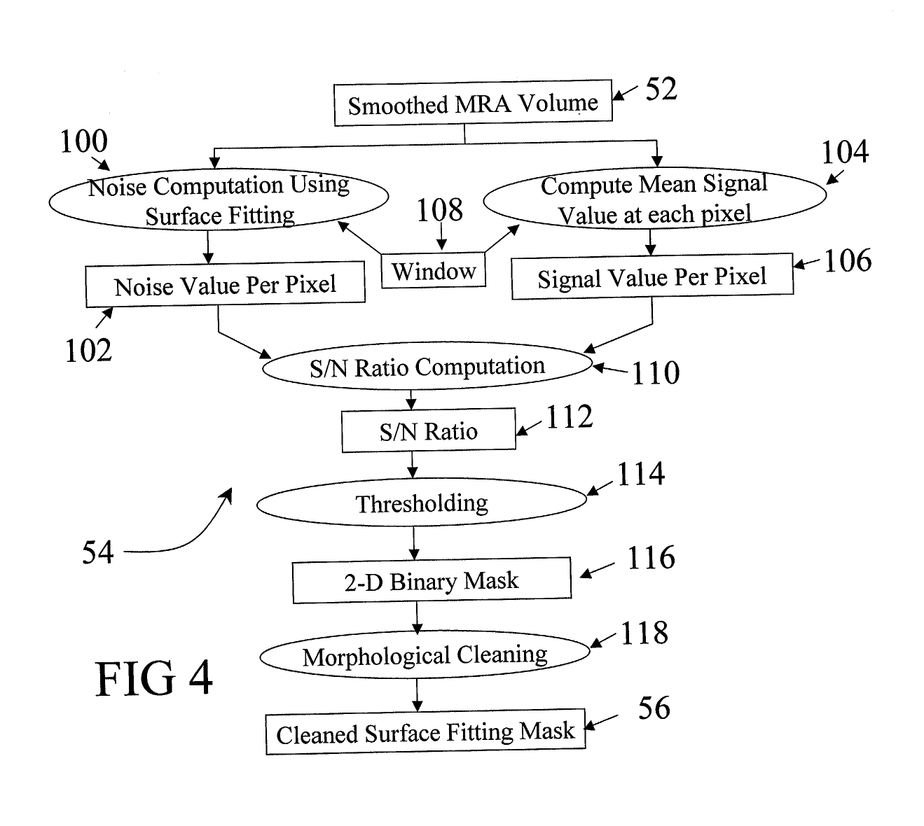

With reference now to FIG. 4, a preferred embodiment of the surface fitting mask generating step 54 is described. The denoised, smoothed, edge preserved and isotropic MRA volume 52 is thresholded to produce the a binary surface fitting mask 56. The MRA volume is preferably processed on a planar basis, e.g. in the exemplary case of carotid imaging each axial slice is processed in sequence.

In order to reduce noise effects, the thresholding is preferably applied to a signal-to-noise ratio (S/N ratio) rather than to the absolute gray scale values. Hence, the mask generating step 54 includes a noise computing processor 100 that calculates the noise value per pixel 102, and a mean signal value computing processor 104 that calculates the signal value per pixel 106 for each pixel in the planar slice.

The noise computing processor 100 preferably calculates the background noise level of each pixel. In a preferred embodiment, the noise computation uses a conventional surface fitting method known to the art. In this method the noise η at pixel (x,y) is given by the error between the real and a fitted surface. Mathematically it is computed by posing the problem using the Least Squares method, where the error is minimized between the real surface and the fitted surface. Since the image is represented as a topological surface, one can take the image value to be a plane surface equation at the pixel point (x,y). The noise level at the pixel point (x,y) is computed by taking the norm of the real and the fitted surfaces. If Î and I are the fitted and real surfaces, the noise level is computed by estimating the norm of the error between them, given as:

η=∥I−Î∥² (2)

The image pixel is modeled as the equation of the planar surface given as I(x,y)=Ax+By+C, where A, B, and C are the coefficients of the surface. This can be done within a window 108 which can for example be a 3×3 pixel window. In matrix form I=Bα:

$$( \begin{matrix}I ( 1 , 1 ) \\ ⋮ \\ I ( n , m )\end{matrix} ) = ( \begin{matrix}{x}_{1} & {y}_{1} & 1 \\ & ⋮ & \\ {x}_{n} & {y}_{m} & 1\end{matrix} ) ( \begin{matrix}A \\ B \\ C\end{matrix} ) \qquad ( 3 )$$

where the indices (n,m) run over the entire window 108. This can be solved for the coefficients A, B, and C using the minimization of the error ∥I−Î∥²=ε². This error is minimized by taking the partial differential of the error with respect to the coefficient vector α=[A B C]^{T}. Thus, α is computed by solving: ∂(ε²)/εα=0. Finally, the fitted surface is computed using the fitted coefficients and basis function location. Since the vessel cross-section has the highest contrast value, the noise value is low and the signal value is high, and so the signal-to-noise ratio is large. This gives the added advantage of raising the level of the vessel cross-section areas.

It will be appreciated that although fitting with an exemplary planar surface of the form I(x,y)=Ax+By+C is described, the method is not so limited. Rather, other surfaces of higher degree can also be applied for the fitting.

The signal computing processor 104 preferably provides an average signal value in a window centered about the pixel (x,y). In the illustrated embodiment of FIG. 4 the same window 108 is used for both the noise and the signal computations, although different windows can instead be used therefor.

Once the noise value per pixel 102 and the signal value per pixel 106 are obtained, e.g. as in the above-described preferred embodiment or by other numerical methods known to the art, a S/N ratio computation step 110 preferably simply ratios the obtained signal value 106 and noise value 102 to calculate the S/N ratio 112. The S/N ratio value of each pixel is thresholded 114 using a threshold calculated from a histogram taken over the entire image volume. This produces a two dimensional binary mask 116 corresponding to the planar slice.

Preferably, a morphological cleaning step 118 is applied to further improve the mask, e.g. by removing outliers and other apparent defects, to produce the cleaned volume of surface fitting binary masks 56. In a preferred embodiment, the cleaning step 118 is performed using a combination of four basic binary operators such as dilation, erosion, opening and closing. Given a structuring element B and the image A, one can mathematically define four fundamental equations for the morphological cleaning transform as follows. The binary dilation is defined as:

A\mathring{+}B={c|c=a+b, for every aεA, bεB} (4).

The binary erosion is defined as:

AΘB={c|c+bεA for every bεB} (5).

The binary closing is mathematically defined in terms of binary dilation and binary erosion as:

A·B=(A\mathring{+}B)ΘB (6).

The binary opening is mathematically defined in terms of binary dilation and binary erosion as:

A∘B=(AΘB)\mathring{+}B (7).

The step 58 (FIG. 2) of estimating the starting points for the arterial and venous sub-systems is described next. As mentioned previously, this step optionally is a manual step performed by an associated user based upon anatomical constraints of the human body which are known to medical personnel and others of ordinary skill in the art. However, due to the large quantity of MRA data typically acquired, in a preferred embodiment the differentiation and identification of starting points of the arterial and venous sub-systems is preferably automated. A preferred embodiment of such an automated system that is applicable to the exemplary carotid vascular system is described. It will be appreciated by those of ordinary skill in the art that the exemplary starting point estimation system described herein for the carotid vascular system is readily modified to accommodate other vascular systems based upon the known anatomical constraints of those systems. The concept of applying anatomical constraints to the identification and differentiation of arteries and veins comes from the recognition that the way blood flows in the arteries and veins and the way in which the arteries and veins are spaced apart in the body is grossly similar in certain respects for most individuals. Hence, the blood flow information which is recorded by the scanner 10 (FIG. 1) is interpreted by the post-acquisition vascular processor 46 by comparing the geometry of the cross-section with the known spatial constraints. Thus using the spatial geometric constraints and the geometric features of the cross-sections, the arteries and veins can be identified and differentiated as described below.

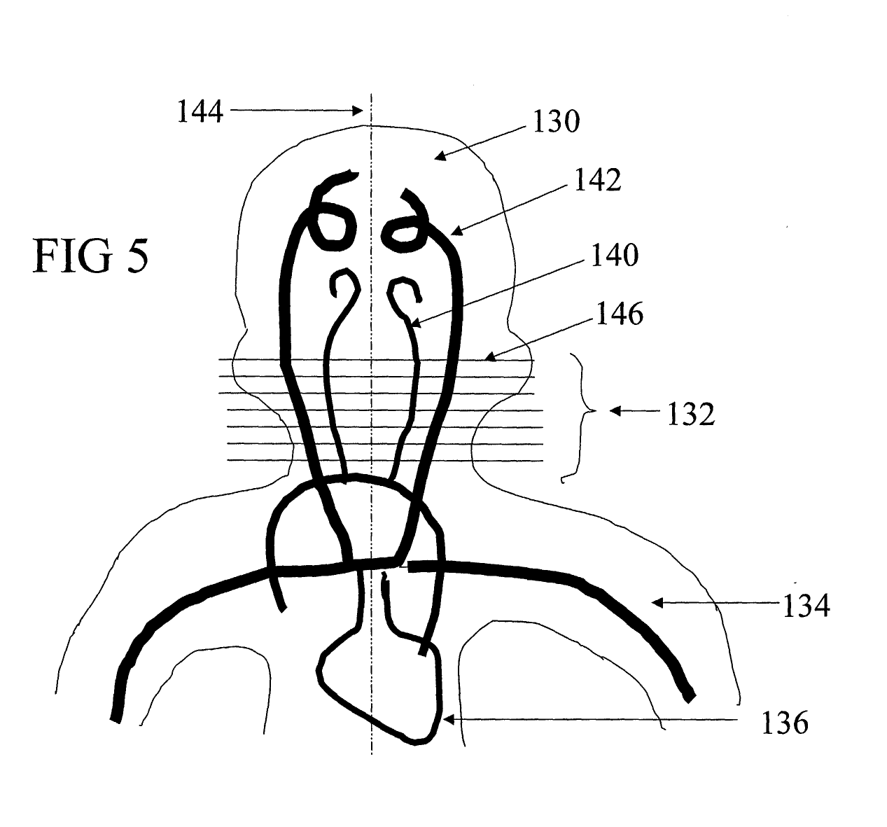

With reference now to FIG. 5, a coronal sectional view of an upper portion of a typical human being includes a head 130, a neck area 132, arms 134, and a heart 136. Additionally, the major carotid arteries 140 and the major carotid veins 142 are shown. In a typical human being, the major carotid arteries 140 are disposed closer to the body centerline 144 as compared with the major carotid veins 142. This provides a critical spatial anatomical constraint.

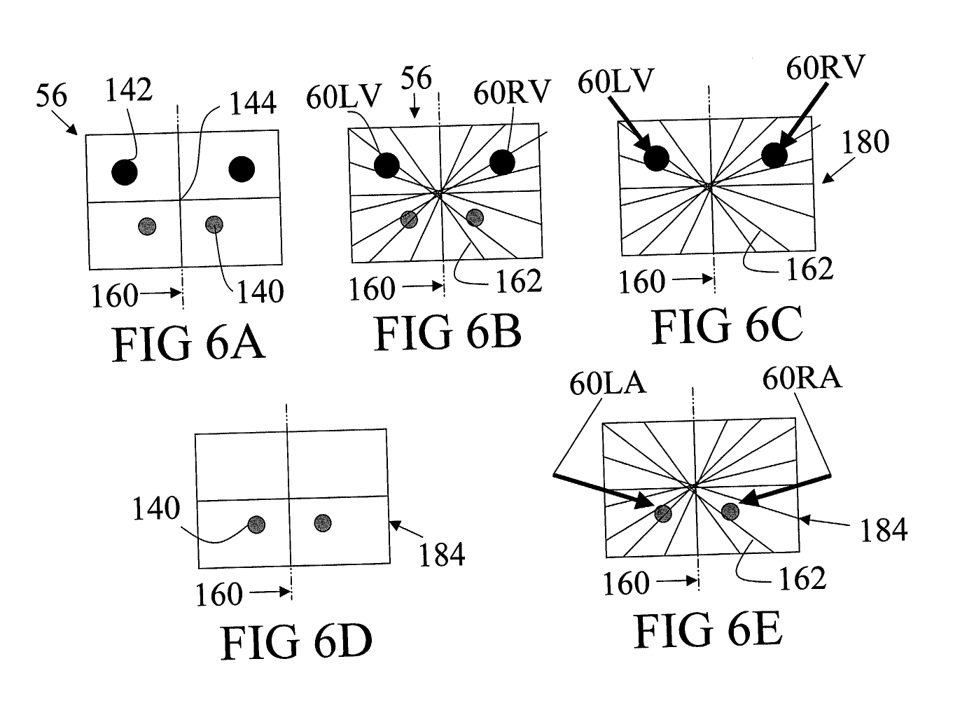

This relative arrangement of the carotid arteries and veins is also seen in FIG. 6A which shows a surface fitting mask slice 56 corresponding to an axial slice 146 indicated in FIG. 5. Additionally, it is seen in FIG. 6A that the major carotid arterial vascular sub-system 140 and the major carotid venous sub-system 142 are typically approximately biaxially symmetric with respect to the sagittal plane 160.

Thus, the carotid vascular system has at least two distinctive anatomical or morphological constraints which are optionally used to automatically differentiate starting points for the venous and arterial sub-systems. First, the arteries 140 are typically closer to the centerline 144 of the body as compared with the veins 142. Second, the general biaxial symmetry of the body about the sagittal plane 160 extends to the carotid vascular system. Of course, other appropriate anatomical constraints can also be applied, either in addition to or in substitution for the above two constraints. For example, it is known that in the carotid vascular system blood typically flows upward, e.g. away from the heart, in the carotid arteries and downward, e.g. back toward the heart, in the carotid veins. Thus, if the MRA imaging technique provides flow direction information, the blood flow direction can be applied as an anatomical constraint. It will also be appreciated that while the discussed constraints are particularly applied herein to the carotid vascular system, similar constraints will apply to most other vascular systems of interest, such as the vascular systems of the leg, arm, torso, and et cetera.

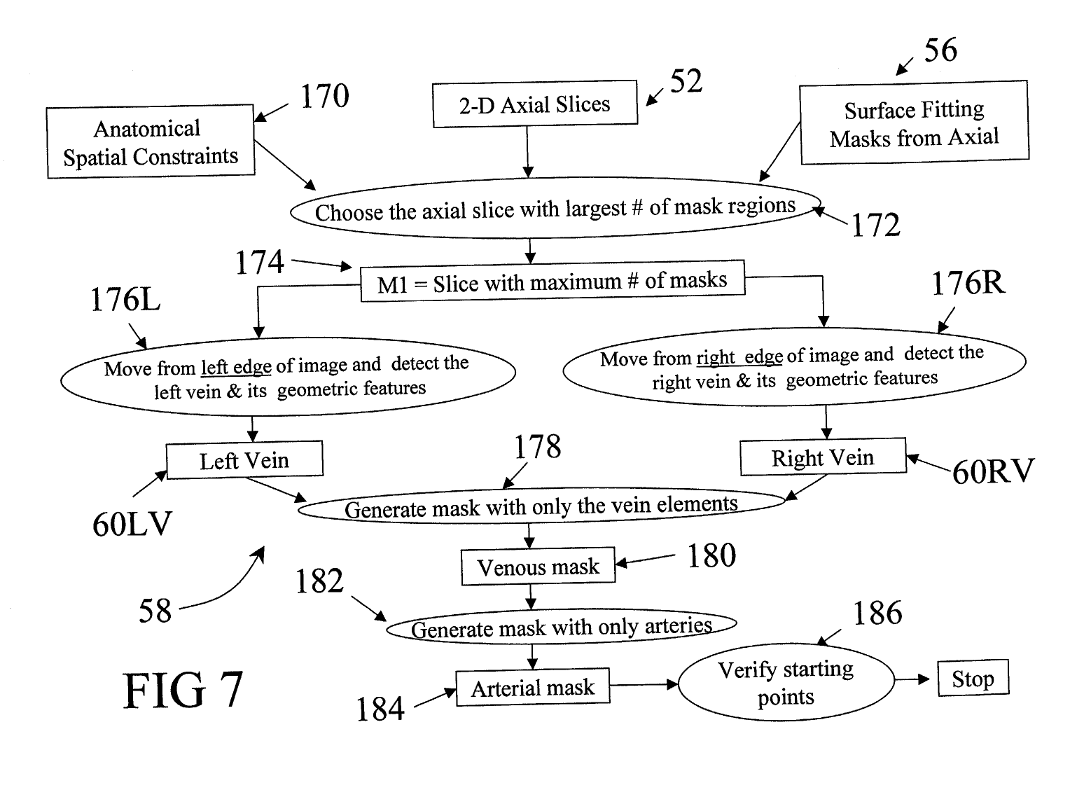

With reference to FIGS. 5-6E along with reference to FIG. 7, the artery-vein starting point estimating step 58 is now described. The estimating step 58 takes as inputs appropriate anatomical constraints 170, e.g. the two distinctive geometrical constraints of the exemplary carotid vascular system discussed above; the isotropic smoothed MRA volume data 52, preferably in the form of the two dimensional axial slices 146; and the surface fitting masks 56, again preferably in the form of axial slices.

In a step 172 the surface fitting mask slices 56 are sorted through to identify a preferred axial slice mask 174 for the starting point identification. In a preferred embodiment, that mask which has the largest number of intersecting blood vessels is the preferred mask 174, as this choice reduces that likelihood of missing an artery or a vein by working with the slice that passes through the most dense vascular region.

The veins are preferably first identified. Based on the constraint that the veins are the outermost blood vessels, the image is traversed starting at the extreme left, and the first blood vessel mask elements encountered are recognized as veins in a step 176L. In view of the typical biaxial symmetry of the carotid vascular system, a similar search is initiated from the rightmost side in a parallel step 176R. In a preferred embodiment, the steps 176L, 176R are performed using radial flow lines 162 (shown in FIGS. 6B, 6C, and 6E) that are computed in pre-selected directions spanning the entire radial range. The mask elements farthest out are taken to correspond to veins. The searching steps 176L, 176R identify a left vein starting point 60LV and a right vein starting point 60RV, respectively, in the mask 56, as seen in FIG. 6B.

With the mask elements that correspond to veins identified, a mask containing only the veins, and not the arteries, is generated in a step 178. In a preferred embodiment, the step 178 is implemented by logically “AND”ing the left and right venous masks to generate the venous mask 180 of FIG. 6C, which shows the vein starting points 60LV, 60RV.

Having generated the venous mask 180, generation of a corresponding arterial mask in a step 182 preferably involves subtracting the venous mask 180 from the original mask 56 to obtain an arterial mask 184 as shown in FIG. 6D. The artery starting points are obtained from the arterial mask 184, preferably by performing a search using the radial flow lines 162 similar to the venous search. As shown in FIG. 6E, the search preferably identifies the left and right arteries 60LA, 60RA.

Preferably, the identification of arterial and venous starting points 60LV, 60RV, 60LA, 60RA is verified in a step 184. The verification can be a manual verification by an associated user. In a preferred embodiment, the verification advantageously uses the second distinctive constraint on the anatomy of the carotid vascular system, namely the biaxial symmetry, to verify that the venous starting points 60LV and 60RV are approximately symmetrically placed about the sagittal plane 160 and are similar in cross-section to one another. Similarly, the arterial starting points 60LA and 60RA are verified to be approximately symmetrically placed about the sagittal plane 160 and similar in cross-section to one another.

Satisfaction of these biaxial symmetry conditions is a strong indication of correct identification of the starting points 60. However, it will be recognized that situations can arise in which the biaxial symmetry will be reduced for a particular patient. For example, a patient whose left carotid artery is partially blocked will typically show a reduced arterial cross-sectional symmetry due to the reduced blood flow in the partially blocked carotid artery and the additional compensating blood flow in the right carotid artery. Such situations are advantageously resolved by falling back upon manual arterial and venous identification for these anomalous medical cases. Nonetheless, the automated artery and vein starting point identification provides a fast and accurate identification in typical cases.

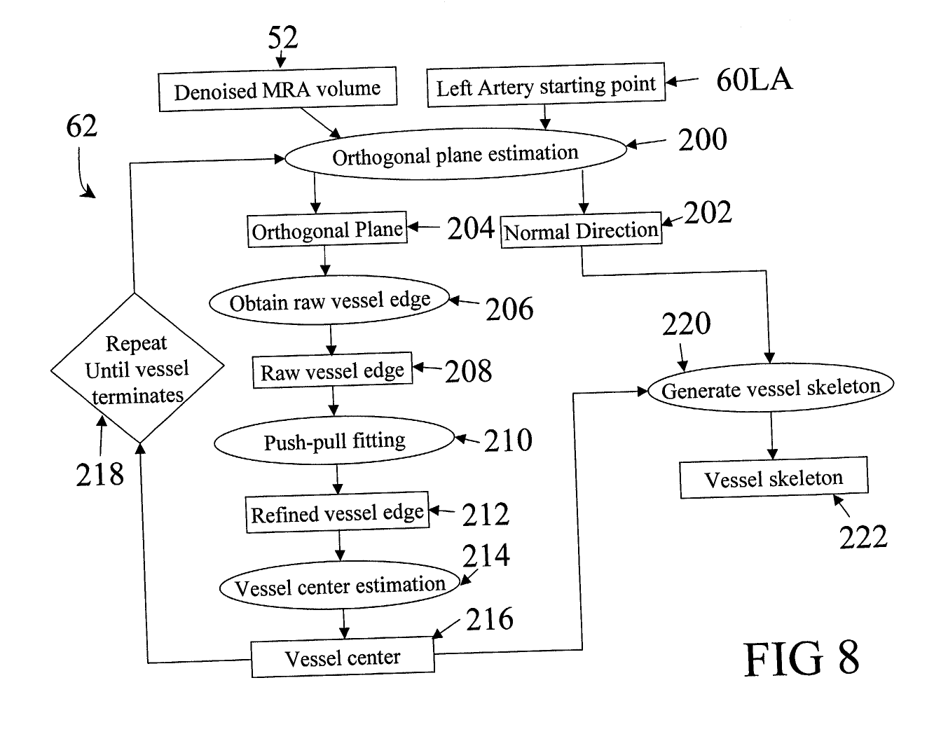

With reference now to FIG. 8, an overview of a preferred embodiment of the blood vessel tracking system 62 is described. The blood vessel tracker 62 tracks the blood vessels from the starting points 60. In FIG. 8, the blood vessel tracker is described in exemplary fashion as tracking the left artery 60LA. It is to be appreciated, however, that the vessel tracker 62 is preferably applied to each blood vessel starting point 60 in either a sequential or a parallel manner, e.g. at least the starting points 60LA, 60RA, 60LV, 60RV are preferably each tracked by the blood vessel tracker 62 in the exemplary case of MRA imaging of the carotid vascular system.

In a step 200, the MRA data is analyzed using differential geometry methods to identify the blood vessel direction 202 and the plane orthogonal thereto 204. In a step 206, the orthogonal plane is analyzed, preferably by convolving the gradient of a Gaussian function, to obtain the raw vessel edges 208. The approximate, i.e. raw, vessel edges are refined in a step 210, preferably using a push-pull fitting technique, to generate refined blood vessel edges 212 that more accurately reflect the actual extent of the blood vessel including stenosis and other effects. With the vessel cross-section well defined, a vessel center estimation step 214 estimates the blood vessel center 216. The steps 200, 206, 210, and 214 are preferably repeated 218 in discrete increments along the blood vessel direction 202 until the entire blood vessel, e.g. the left artery 60LA, is segmented. With the blood vessel centers 216 and the blood vessel directions 202 known for the length of the blood vessel, in a step 220 the blood vessel skeleton 222 can be generated, e.g. by spatial interpolation.

It will be appreciated that the blood vessel tracking system just described with reference to FIG. 8 is greatly simplified. Additional features, such as means for addressing blood vessel bifurcation and detection and accommodation of other vascular features are also advantageously included, but are not shown in the overview FIG. 8. The steps comprising the tracking system 62 will be described in greater detail next.

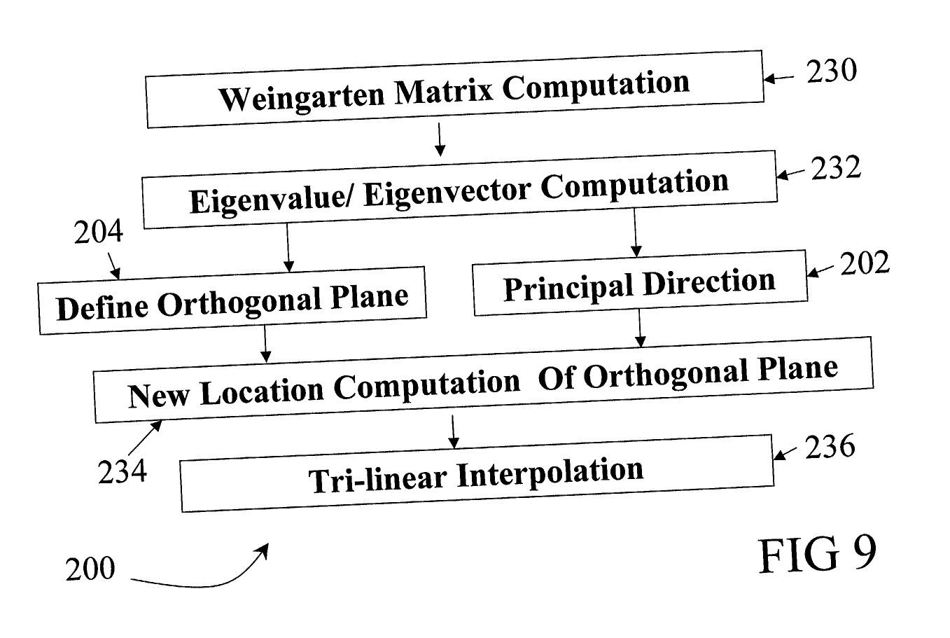

With reference now to FIG. 9, a preferred embodiment of the orthogonal plane estimation step 200 is described. The orthogonal plane is the plane containing the vessel cross-section. The concepts of differential geometry, curves and surfaces are preferably used for estimating the orthogonal plane. In 2-D images, lines or curves have two directions, one direction is along the line or curve and second direction that is orthogonal to the line or curve. These directions are the vectors corresponding to the eigenvalues of the Hessian matrix at a given point. For a 2-D image, the two eigenvalues are the two curvatures at that point, i.e. the maximum curvature (k₁) and the minimum curvature (k₂). Using the differential geometry, one can represent the amplitude of the curvature and its corresponding direction by the eigenvalues and eigenvectors of the Weingarten matrix W=F₁⁻¹F₂, where F₁ is a function of the partial derivatives of the image in x and y directions, and F₂ is the function of the second partial derivatives in x and y directions.

In a preferred embodiment of the orthogonal plane estimation step 200, a similar concept is applied to the 3-D image volume of angiography data sets. The volume is modeled as a four-dimensional surface S given by:

$$\overline{S} = [ \begin{matrix}x \\ y \\ z \\ I ( x , y , z )\end{matrix} ] \qquad ( 8 )$$

where the first three elements are the spatial coordinates (x,y,z) and the fourth element is the image intensity I(x,y,z) at the voxel location (x,y,z). In this case, there are three principal curvatures. Two curvatures correspond to the two orthogonal directions in the cross-sectional plane of the tubular blood vessel, while the third principal curvature corresponds to the vessel direction or vessel orientation. The three directions can be computed using the Weingarten matrix which is a combination of the first and second form of the hypersurface, i.e. W=F₁⁻¹F₂, where F₁ is the fundamental form of hypersurface and a function of Iₓ, I_{y} and I_{z}, the three partial derivatives of the image volume, and F₂ is the second fundamental form of hypersurface and is a combination of the second partial derivatives Iₓₓ, I_{xy}, I_{xz}, I_{yy}, I_{yz}, and I_{zz}. More explicitly,

W=F₁⁻¹F₂

where

$${F}_{1} = [ \begin{matrix}1 + {I}_{x}^{2} & {I}_{x} {I}_{y} & {I}_{x} {I}_{z} \\ {I}_{x} {I}_{y} & 1 + {I}_{y}^{2} & {I}_{y} {I}_{z} \\ {I}_{x} {I}_{z} & {I}_{y} {I}_{z} & 1 + {I}_{z}^{2}\end{matrix} ] , {F}_{2} = [ \begin{matrix}{I}_{x x} & {I}_{x y} & {I}_{x z} \\ {I}_{x y} & {I}_{y y} & {I}_{y z} \\ {I}_{x z} & {I}_{y z} & {I}_{z z}\end{matrix} ] . \qquad ( 9 )$$

Thus, the orthogonal plane estimation step 200 has a first step 230 of constructing the Weingarten (W) matrix according to equation (9). The eigenvectors and eigenvalues of this matrix are obtained using mathematical manipulations that are well known to those of ordinary skill in the art in a step 232. the three directions at the point (x,y,z) under consideration are the eigenvectors of the W matrix. The direction corresponding to the minimum curvature is the direction of the blood vessel 202. The plane passing though the point (x,y,z) whose normal is the blood vessel direction 202 is the orthogonal plane 204, i.e. the plane of the blood vessel cross-section 204. Thus, the plane is defined in space by the two eigenvectors not corresponding to the blood vessel direction 202.

However, because the orthogonal plane 204 is in general an oblique plane relative to the principle axes of the isotropic MRA volume 52, e.g. relative to the normals of the axial, sagittal, and coronal planes, an isotropic pixel representation of the plane, e.g. comprising pixels S(i,j) where i and j vary uniformly, is generated in a step 234. The intensities at these pixel locations is preferably obtained by trilinear interpolation of the MRA volume 52 voxels in a step 236 to obtain an isotropic pixel representation of the orthogonal plane 204.

With reference returning now to FIG. 8, once the orthogonal plane 204 is estimated, the raw contour or raw vessel boundary 208 is found in the step 206. A preferred embodiment uses scale-space edge detection, in which the scale-space image is preferably computed by convolving the gradient of a Gaussian function with the oblique orthogonal plane image according to:

L(\overline{x}, σ)=σ^{γ}[∇G(\overline{x}, σ)ΘI(\overline{x})] (10)

where I is the oblique image, ∇G is the gradient of the Gaussian function, and σ is a fitting parameter discussed below. The scale-space estimates the diameter of the vessel cross-section, and thereby establishes the raw edges 208. The raw edges of the vessel cross-section include those points of the image which are on the radial lines originating from the estimated center of the blood vessel cross-section, said center corresponding to the center of the fitted Gaussian function (G). The locations of the raw edge points are preferably identified on the basis of those points whose scale space intensity values are above a selected threshold.

The scale-space images are computed according to equation (10) by normalizing the convolution operation by the scale-space factor σ^{γ} which is the standard deviation of the Gaussian function (G) powered by the constant scale factor γ. Since the optimal value of σ, i.e. that value which gives the best scale-space edges, is not known, σ is preferably optimized during the computation of the scale-space image L which is used in computing the raw edges. The optimization of σ can be by any method known to the art. Since the raw edges will be refined in the push-pull fitting step 210, the value of σ is preferably calculated in an approximate and rapid manner. In a preferred embodiment, an optimized σ is obtained by calculating the scale space for several values of σ and selecting that scale space and corresponding σ that best fits the data.

Due to the linear system noise, noise in the images, blood vessel stenosis, low radial sampling resolution, the partial volume averaging, and other factors, the raw edges are not expected to be highly accurate and will typically include some inaccurate edges. Therefore, the raw vessel edges 208 are preferably refined in a step 210. In a preferred embodiment, the refining step 210 uses a regional force or “push-pull” approach for optimizing the blood vessel cross-section estimation.

A regional force is a computed force that acts on a point of the raw edge 208. The regional force is computed using the pixel distribution in the neighborhood of the raw edge point. This force can be viewed as a force resulting from a pixel classification scheme. In a preferred embodiment, a fuzzy pixel classification is used to account for the fact that a pixel in the image can have intensity contributions from different substances, e.g. a contribution from a static tissue and a contribution from blood. Such a pixel is advantageously classified in a fuzzy manner according to the fractional contribution of blood and static tissue to the total intensity value. Such a “mixed” pixel may or may not belong to the vessel cross-section region, dependent upon the fractional blood contribution to the total intensity.

A fuzzy pixel classification algorithm typically requires as an input at least the number of classes in the image. For medical imaging, the number of classes in the image usually corresponds to the number of tissue types included (or potentially included) in the image. A fuzzy membership function classifies each pixel according to its relative intensity contributions from the various classes.

There are several algorithms known to the art for computing fuzzy membership functions. A preferred algorithm is the Fuzzy C Mean (FCM) method. Because of its ease of implementation for spectral data, the FCM method is preferred over other known pixel classification techniques. However, it will be appreciated that other fuzzy pixel classification methods can be employed for calculating the regional forces.

The edge refinement process 210 operates on the scale space using the raw vessel edges 208 and the pixel classifications, e.g. the FCM pixel classifications. The refined edges are preferably computed using a regional deformable model implemented in level set framework. The raw edges are characterized by a collection of points, e.g. 12 to 24 points. These raw edge points are pulled and pushed towards a more accurate representation of the edge of the vessel cross-section.

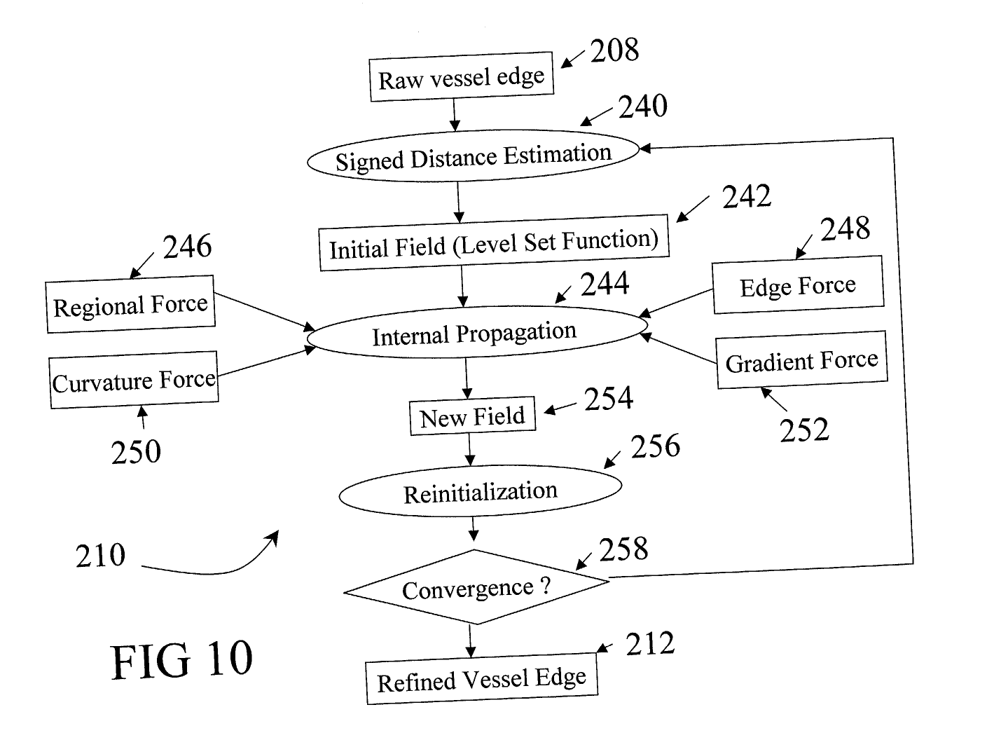

With reference now to FIG. 10, the deformation procedure whereby the refined vessel edges are obtained is described. The process of deformation is done in the level set framework. First a narrow band is specified around the raw contour 208. The level set field is computed in this narrow band using the signed distance transform in a step 240 to obtain the initial field or level set function 242. The signed distance transform is so-called because the distances are assigned to the left and right of the raw edge contour which are positive or negative. It is this field 242 in which the new contour is searched which gets closer to the vessel cross-section.

In a preferred embodiment, the step of propagating the edges 244 is described mathematically by:

$${φ}_{x , y}^{n + 1} = {φ}_{x , y}^{n} - Δ t [ {V}_{r e g i o n a l} ( x , y ) + {V}_{e d g e} ( x , y ) - {V}_{c u r v a t u r e} ( x , y ) + {V}_{g r a d i e n t} ( x , y ) ] \qquad ( 11 )$$

where V_{regional}, V_{edge}, V_{curvature}, and V_{gradient} are the corresponding computed forces 246, 248, 250, 252, which have units of speed, e.g. push speed or pull speed, Δt is a time difference, and φⁿ and φⁿ⁺¹ are the current and next iteration values of the level set field 242, 254.

The initial field 242 is transformed to the new field 254 once acted upon by the regional, edge, gradient and curvature forces 246, 248, 250, 252 in the internal propagation step 244. The output is the new field 254. The new contour, also called an isocontour, is searched in this new field which is more closer to the true vessel cross-section. This isocontour is extracted in a re-initialization step 256 and the isocontour is checked for convergence 258. The steps 240, 244, 256 preferably iterate until convergence is reached. The final contour is the refined vessel cross-section representation 212. The process illustrated in FIG. 10 is performed for each oblique plane that is normal the principal direction of the blood vessel, e.g. the exemplary left artery 60LA. In this manner the blood vessel cross-section 212 is obtained along its entire length. Since the cross-section estimation process uses the level set approach, it is very fast as it is done using a back-pointer method. This means the field computation or the signed distance transform computation uses a sorting method that is based on a heap sort, which uses the back-pointer method. Those skilled in the art can use Bayeisan classification, K-mean classification, or training models.

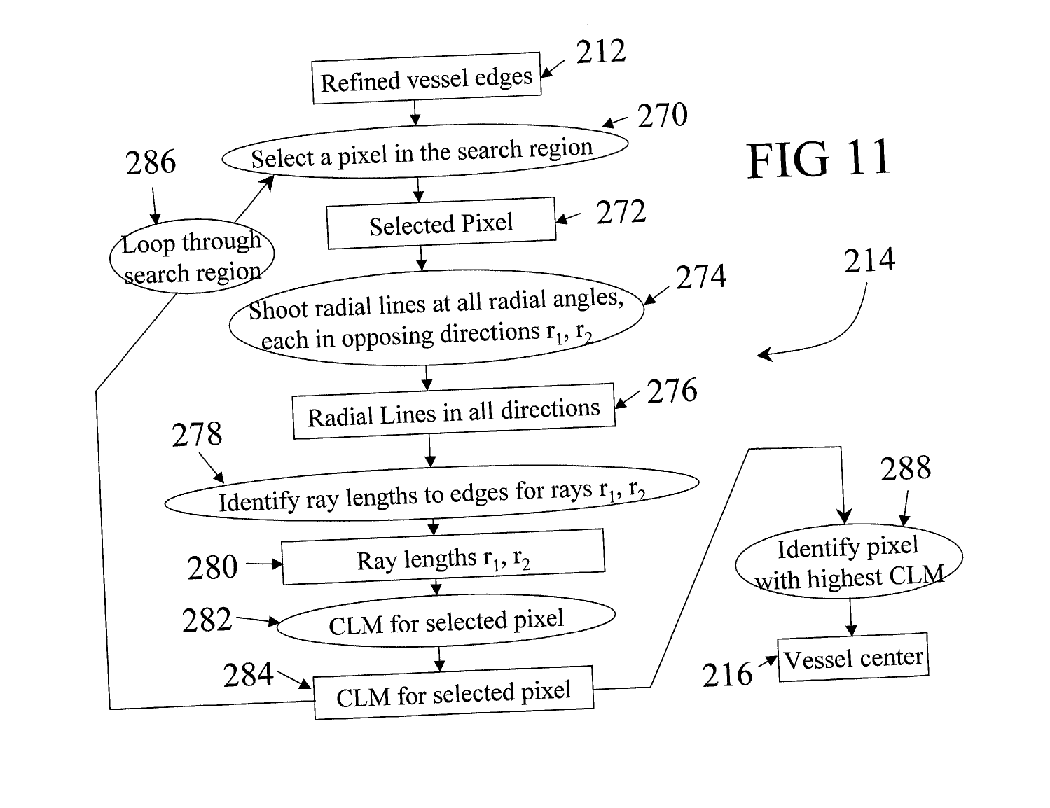

With reference now to FIG. 11, the estimation 214 of the vessel center 216 is described. A pixel 272 is selected in a step 270, preferably from within the refined blood vessel edges 212. In a preferred embodiment, a center likelihood measure is calculated for the selected pixel 272 as follows. Radial lines are drawn 274 from the pixel 272 in all radial directions. Each radial line 276 shoots out in two opposing directions r₁ and r₂, i.e. the direction r₁ is at a 180° radial angle away from r₂. The radial lines 276 intersect the refined vessel edges 212. The length of the rays r₁, r₂ of each radial line 276 from the pixel 272 to the refined edge 212 is computed in a step 278 to obtain the ray lengths r₁ and r₂ 280 from the selected pixel 272 to the refined vessel edges 212. Given the ray lengths r₁ and r₂ 280 for all the radial lines 276, the center likelihood measure (CLM) is calculated in a step 282 as:

$$C L M = \frac{{\sum }_{l} min \{ {r}_{1} ( l ) , {r}_{2} ( l ) \}}{{\sum }_{l} max \{ {r}_{1} ( l ) , {r}_{2} ( l ) \}} \qquad ( 12 )$$

where min{r₁(l),r₂(l)} is the minimum value of the two oppositely directed rays corresponding to the line l, max{r₁(l),r₂(l)} is the maximum value of the two oppositely directed rays corresponding to the line l, and the summations are over the radial lines (l) 276 at every angle. The center likelihood measure (CLM) 284 is thus obtained. The steps 270, 274, 278, 282 are repeated 286 for every pixel in the search region, e.g. for every pixel contained within the refined vessel edges 212. That pixel which has the maximum CLM 284 is identified in a step 288 as the vessel center 216.

With reference again to FIG. 8, once the vessel center is obtained for all the oblique planes, the vessel skeleton 222 is preferably generated in a step 220. Generation of the vessel skeleton is preferably by interpolatively connecting the vessel centers 216 in three-dimensional space, optionally using the computed normal direction 202 as a guide.

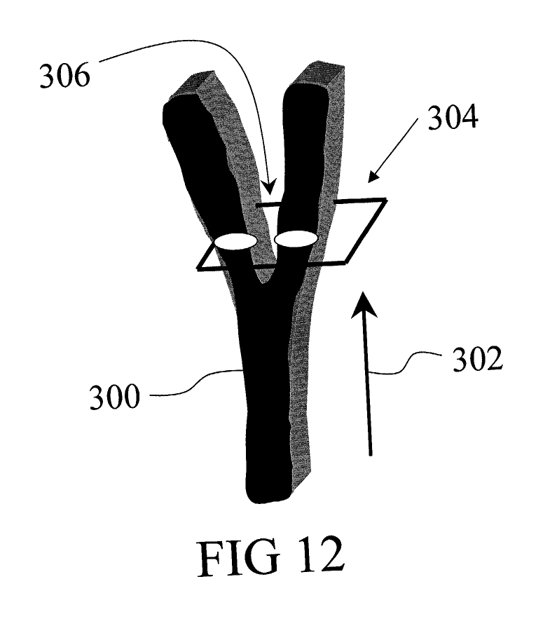

With reference now to FIG. 12, while tracking the blood vessel 300 in a direction 302 along the vessel centers of successive oblique planes, e.g. tracking the left artery 60LA according to the exemplary sequence of FIG. 8, it can occur that at a certain oblique plane 304 a bifurcation point 306 is encountered. In a preferred embodiment, the bifurcation point 306 is tagged and the tracking process 62 is continued, e.g. according to FIG. 8. Once a particular branch is completely tracked, the tagged locations are revisited and the tracking process 62 of FIG. 8 is applied to the branch. The process continues until no tagged branches remain untracked. At this point, the particular tree corresponding to the starting point, e.g. the left artery starting point 60LA in the exemplary FIG. 8, is fully tracked and segmented. The tracking process of FIG. 8 is repeated for each starting point 60, e.g. 60LA, 60RA, 60LV, 60RV, to completely track the vascular system of interest and thus generate the segmented arterial and venous vascular systems 64.

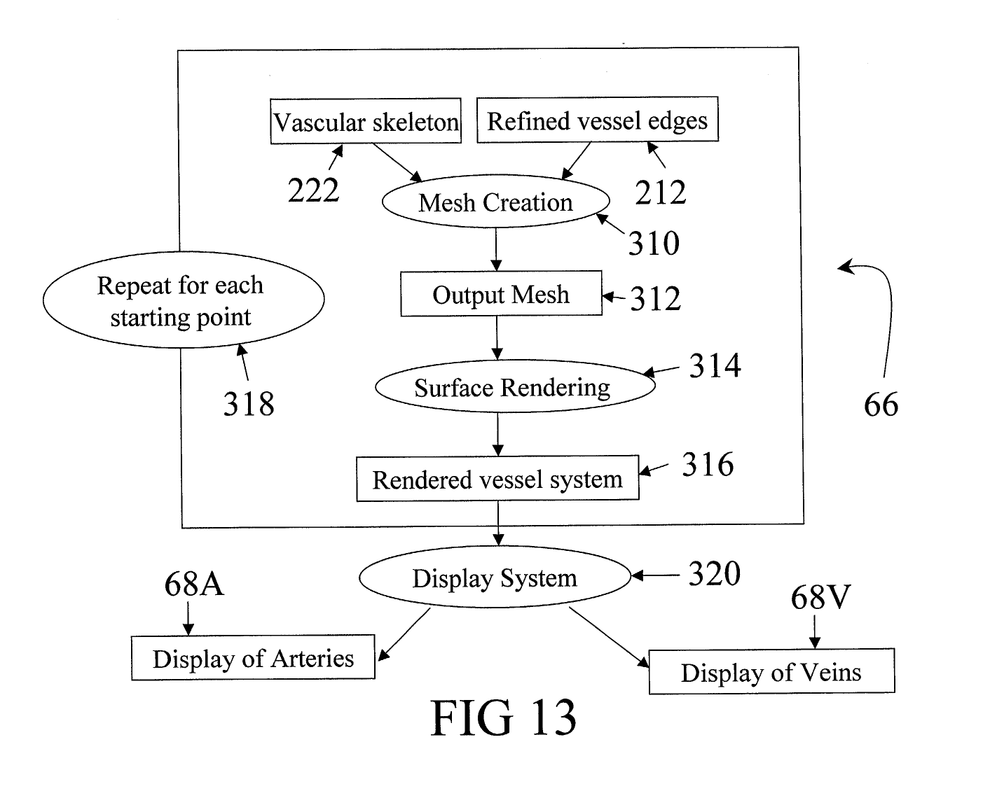

With reference now to FIG. 13, knowledge of the vascular skeleton 222 and the refined vessel edges 212 for the vascular system that initiates at each starting point 60 enables generation of a graphical display of the vascular system in a step 66. Graphical display of three-dimensional structures is well known to those of ordinary skill in the art. In a preferred embodiment, a mesh creation step 310 creates an output mesh 312, e.g. a wire mesh, corresponding to the blood vessel sub-system. A surface rendering step 314 “fills in” the output mesh 312 to generate the rendered vessel system 316. The steps 310, 314 are repeated for the tracked and segmented vessel system of each starting point in a loop step 318. A display system 320 preferably displays the arteries 68A and the veins 68V on an appropriate output devices, such as a color monitor, color printer, or the like. Preferably, the arteries 68A and the veins 68V are graphically differentiated, e.g. by coloring the arteries red and the veins blue.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A method for processing magnetic resonance angiographic (MRA) data, comprising:
smoothing the MRA data;
converting the MRA data to an isotropic format;
generating a binary surface fitting mask from the isotropic MRA data that differentiates vascular regions from surrounding tissue;
identifying vascular starting points indicated by the binary surface fitting mask;
tracking the vascular system corresponding to each starting point; and
displaying the tracked vascular system.

2. The method according to claim 1, further comprising:
differentiating the arteries and the veins in the binary surface fitting mask data based on anatomical constraints.

3. The method according to claim 2, wherein the differentiating step includes:
differentiating veins and arteries based on the distance of the vascular starting points from a centerline of the body.

4. The method according to claim 2, wherein the differentiating step includes:
differentiating veins and arteries based on anatomical symmetry of the vascular system with respect to the sagittal plane of the body.

5. The method according to claim 1, further comprising:
confirming the vascular starting points based on anatomical symmetry of the vascular system with respect to the sagittal plane of the body.

6. The method according to claim 1, wherein the step of generating a binary surface fitting mask includes:
calculating a noise value per pixel;
calculating a signal value per pixel;
calculating a signal-to-noise ratio per pixel;
thresholding said signal-to-noise ratio; and
repeating the steps of calculating a noise value per pixel, calculating a signal value per pixel, calculating a signal-to-noise ratio per pixel, and thresholding said signal-to-noise ratio for each pixel in the masked plane.

7. The method according to claim 1, wherein the tracking step includes:
estimating an oblique plane that is orthogonal to the vessel;
determining the vessel edges in the oblique plane;
determining an estimated vessel center in the oblique plane; and
repeating the steps of estimating an oblique plane that is orthogonal to the vessel, determining the vessel edges in the oblique plane, and determining the vessel center for a plurality of points of the vessel.

8. The method according to claim 7, wherein the step of determining an oblique plane includes:
computing a Weingarten matrix for the vector space (x, y, z, I(x,y,z))^{T} where x, y, and z are spatial coordinates, and I(x,y,z) is the MRA signal intensity at the location (x,y,z);
obtaining the eigenvalues and the eigenvectors of the Weingarten matrix;
identifying a vessel direction as the eigenvector corresponding to the minimum eigenvalue; and
identifying an orthogonal plane as one of a plane defined by the eigenvectors other than the eigenvector corresponding to the minimum eigenvalue, and a plane that is orthogonal to the vessel direction.

9. The method according to claim 7, wherein the step of determining the vessel edges in the oblique plane includes:
determining a raw vessel edge; and
refining the raw vessel edge to obtain a refined vessel edge representation.

10. The method according to claim 9, wherein the step of determining a raw vessel edge includes:
computing a scale space image by convolving the gradient of a Gaussian function with the oblique orthogonal plane image.

11. The method according to claim 9, wherein the step of determining a raw vessel edge includes:
computing a scale space image by convolving the gradient of a Gaussian function with the oblique orthogonal plane image according to:
L(\overline{x}, σ)=σ^{γ}[∇G(\overline{x}, σ)ΘI(\overline{x})]
where I is the oblique image, G is the Gaussian function, and σ is a fitting parameter.

12. The method according to claim 9, wherein the step of refining the raw vessel edge to obtain a refined vessel edge representation includes:
calculating a fuzzy membership function for the pixels;
defining at least one force acting on the vessel edges based on the fuzzy membership function;
adjusting the vessel edge representation based on the computed action of the at least one force; and
repeating the steps of defining at least one force and adjusting the vessel edge representation until a convergence is obtained.

13. The method according to claim 7, wherein the step of determining an estimated vessel center includes:
calculating a center likelihood measure for a plurality of pixels contained within the vessel edges; and
selecting a pixel from the plurality of pixels based on the calculated center likelihood measures.

14. The method according to claim 13, wherein the step of calculating a center likelihood measure includes the steps of:
calculating the distance from the pixel to a plurality of points on the vessel edges.

15. The method according to claim 7, wherein the tracking step further includes:
identifying a bifurcation point;
tagging said bifurcation point; and
revisiting the tagged bifurcation point and repeating the tracking step along a vascular branch corresponding to the bifurcation point.

16. A method for tracking a vascular system imaged in a gray scale image of at least a portion of the body, the method comprising:
identifying a starting point for the vascular system;
estimating an oblique plane that is orthogonal to the vessel, said oblique plane being comprised of pixels;
determining the vessel edges in the oblique plane;
determining an estimated vessel center in the oblique plane.

17. The method according to claim 16, wherein the step of determining an oblique plane includes:
computing a Weingarten matrix for the vector space (x, y, z, I(x,y,z))^{T} where x, y, and z are spatial coordinates, and I(x,y,z) is the gray scale value at the location (x,y,z);
obtaining the eigenvalues and the eigenvectors of the Weingarten matrix;
identifying a vessel direction as the eigenvector corresponding to the minimum eigenvalue; and
identifying an orthogonal plane as one of a plane defined by the eigenvectors other than the eigenvector corresponding to the minimum eigenvalue, and a plane that is orthogonal to the vessel direction.

18. The method according to claim 16, wherein the step of determining the vessel edges in the oblique plane includes:
determining a raw vessel edge; and
refining the raw vessel edge to obtain a refined vessel edge representation.

19. The method according to claim 18, wherein the step of determining a raw vessel edge includes:
computing a scale space image by convolving the gradient of a Gaussian function with the oblique orthogonal plane image.

20. The method according to claim 18, wherein the step of refining the raw vessel edge to obtain a refined vessel edge representation includes:
calculating a fuzzy membership function for the pixels;
defining at least one force acting on the vessel edges based on the fuzzy membership function; and
adjusting the vessel edge representation based on the computed action of the at least one force.

21. The method according to claim 16, wherein the step of determining an estimated vessel center includes:
calculating a center likelihood measure for a plurality of pixels contained within the vessel edges; and
selecting a pixel from the plurality of pixels based on the calculated center likelihood measures.

22. The method according to claim 21, wherein the step of calculating a center likelihood measure includes the steps of:
calculating the distance from the pixel to a plurality of points on the vessel edges.

23. The method according to claim 16, wherein the step of identifying a starting point for the vascular system includes:
generating a mask from the gray scale image data that differentiates vascular regions from surrounding tissue; and
differentiating arteries and veins in the mask based on anatomical constraints.

24. A method for differentiating arteries and veins in gray scale image data, the method comprising:
generating a mask from the gray scale image data that differentiates vascular regions from surrounding tissue; and
differentiating arteries and veins in the mask based on anatomical constraints.

25. The method according to claim 24, wherein the step of differentiating arteries and veins in the mask based on anatomical constraints includes:
differentiating arteries and veins based on the distance of the vascular starting points from a selected area of the imaged body.

26. The method according to claim 24, wherein the differentiating step includes:
differentiating arteries and veins based on anatomical symmetry of the vascular system with respect to the sagittal plane of the body.

27. An apparatus for performing magnetic resonance angiography comprising:
a magnetic resonance imaging apparatus for generating a first image of a portion of the body;
a vascular mask processor that generates a mask image from the first image in which vascular regions are differentiated from the surrounding tissue;
an artery/vein differentiation processor that receives the vascular mask image and identifies at least one of an artery and a vein therefrom; and
a vascular tracking processor that receives a vessel starting point based on the vascular mask image and calculates a skeleton of the vascular system associated with the starting point.

28. The apparatus as set forth in claim 27, wherein the artery/vein differentiation processor includes:
a collection of anatomical constraints; and
a comparator that compares the mask image with the anatomical constraints and identifies at least one of an artery and a vein based upon the comparison.

29. The apparatus as set forth in claim 27, wherein the vascular tracking processor includes:
a spatial processor that estimates an oblique plane that is orthogonal to the vessel;
an edge processor that determines the vessel edges in the oblique plane; and
a skeleton processor that determines an estimated vessel center in the oblique plane.
